(19) United States
(12) Patent Application Publication
(10) Pub. No.: US 2016/0267522 A1
(43) Pub. Date: Sep. 15, 2016

(54) EXPANDING AN AUDIENCE FOR AN ADVERTISING CAMPAIGN

(71) Applicant: LinkedIn Corporation, Mountain View, CA (US)

(72) Inventors: Jan Schellenberger, Belmont, CA (US); Sanjay Kshetramade, Fremont, CA (US); Kancheng Cao, Palo Alto, CA (US); Ashvin Kannan, Sunnyvale, CA (US); Kun Liu, Sunnyvale, CA (US); Haishan Liu, Sunnyvale, CA (US); Chongzhe Li, Fremont, CA (US); Tingting Cui, Mountain View, CA (US)

(73) Assignee: LinkedIn Corporation, Mountain View, CA (US)

(21) Appl. No.: 14/643,431

(22) Filed: Mar. 10, 2015

(51) Int. Cl. G06Q 30/02

(52) U.S. Cl. CPC G06Q 30/0244; G06Q 30/0246

(57) ABSTRACT

In order to expand the audience for an advertising campaign, a system identifies an expanded audience for the advertising campaign based on characteristics of individuals in the expanded audience and a target audience of the advertising campaign. Then, the system compares a historical cumulative advertising performance metric at a current time for the target audience with a current cumulative advertising performance metric at the current time for the target audience in the advertising campaign. Next, the system selectively changes a probability of showing advertisements in the advertising campaign to individuals in the expanded audience based on the comparison. For example, if a current cumulative number of daily advertising impressions at the current time is less than a historical cumulative number of daily advertising impressions at a current time, the system increases the probability.

### BACKGROUND

1. Field

The described embodiments relate to techniques for selectively providing advertising impressions during an advertising campaign. More specifically, described embodiments relate to techniques for selectively providing advertising impressions to individuals outside of a target audience during an advertising campaign.

2. Related Art

Online advertising is a widely used technique for recruiting new customers and driving sales. For example, an instance of advertisement (which is sometimes referred to as an ‘advertising impression’) may be included in a web page during an advertising campaign.

In order to increase the efficacy of advertising campaigns, targeted advertisements are increasingly common. In a typical targeted advertising campaign, advertising impressions are selectively provided to a target audience based on one or more predefined criteria. In particular, the one or more predefined criteria may specify individuals in the target audience and when advertising impressions are provided.

However, the target audience of a targeted advertising campaign is sometimes specified too narrowly or too precisely. In particular, individuals who do not meet the one or more predefined criteria, but who nonetheless may be interested in the content associated with a targeted advertising campaign, usually do not receive advertising impressions associated with the targeted advertising campaign. Consequently, opportunities to expand the market for a product or a brand may be missed.

### BRIEF DESCRIPTION OF THE FIGURES

FIG. 1 is a block diagram illustrating a system used to provide advertising impressions in accordance with an embodiment of the present disclosure.

FIG. 2 is a flow chart illustrating a method for expanding an audience for an advertising campaign in accordance with an embodiment of the present disclosure.

FIG. 3 illustrates communication between the electronic devices of FIG. 1 in accordance with an embodiment of the present disclosure.

FIG. 4 is a drawing illustrating a target audience and an expanded audience for an advertising campaign in accordance with an embodiment of the present disclosure.

FIG. 5 is a drawing illustrating a social graph in accordance with an embodiment of the present disclosure.

FIG. 6 is a drawing illustrating cumulative advertising impressions as a function of time in accordance with an embodiment of the present disclosure.

FIG. 7 is a block diagram illustrating a computer system that performs the method of FIGS. 2 and 3 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In order to expand the audience for an advertising campaign, a system identifies an expanded audience for the advertising campaign based on characteristics of individuals in the expanded audience and a target audience of the advertising campaign. Then, the system compares a historical cumulative advertising performance metric at a current time for the target audience with a current cumulative advertising performance metric at the current time for the target audience in the advertising campaign. Next, the system selectively changes a probability of showing advertisements in the advertising campaign to individuals in the expanded audience based on the comparison. For example, if a current cumulative number of daily advertising impressions at the current time is less than a historical cumulative number of daily advertising impressions at a current time, the system increases the probability.

In these ways, the system may expand the audience for the advertising campaign to include related or similar individuals to those in the target audience. While the individuals in the expanded audience may not meet all of the predefined criteria associated with the advertising campaign (which specify the target audience), the individuals in the expanded audience may be interested in the content of the advertising campaign (such as a product or a job opportunity). Moreover, this advertising technique may allow advertising impressions to be provided to the expanded audience when it makes sense, such as when the daily cumulative advertising impressions are running below the historical cumulative norm, which usually means that the advertising campaign is running below its allotted daily budget. Consequently, the advertising technique may allow the system to opportunistically expand the audience of the advertising campaign in a targeted and cost-efficient manner, which may increase the effectiveness of the advertising campaign. In addition, the characteristics used by the advertising technique may be based on a social network, such as a social network that facilitates interactions among users, such as the creation and maintenance of professional and/or personal relationships. Therefore, the advertising technique may increase the value of the social network.

In the discussion that follows, an individual or a user may include a person (for example, an existing user of the social network or a new user of the social network). Also, or instead, the advertising technique may be used by an organization, a business, and/or a government agency. Furthermore, a ‘business’ should be understood to include for-profit corporations, non-profit corporations, groups (or cohorts) of individuals, sole proprietorships, government agencies, partnerships, etc.

Furthermore, as an illustration, in the discussion that follows the historical cumulative advertising performance metric includes a historical cumulative number of daily advertising impressions at the given time for the target audience based on previous advertising campaigns. However, in other embodiments the historical cumulative advertising performance metric can be: a historical cumulative number of daily advertising impressions at the given time for the target audience based on previous days in the advertising campaign; a historical cumulative consumption of a daily budget at the given time for the target audience based on previous advertising campaigns, and a historical cumulative consumption of the daily budget at the given time for the target audience based on previous days in the advertising campaign. Similarly, as an illustration, in the discussion that follows the current cumulative advertising performance metric includes a current cumulative number of daily advertising impressions at the given time for the target audience in the advertising campaign. However, in other embodiments the current cumulative advertising performance metric can be a current cumulative consumption of the daily budget at the given time for the target audience based on the advertising campaign.

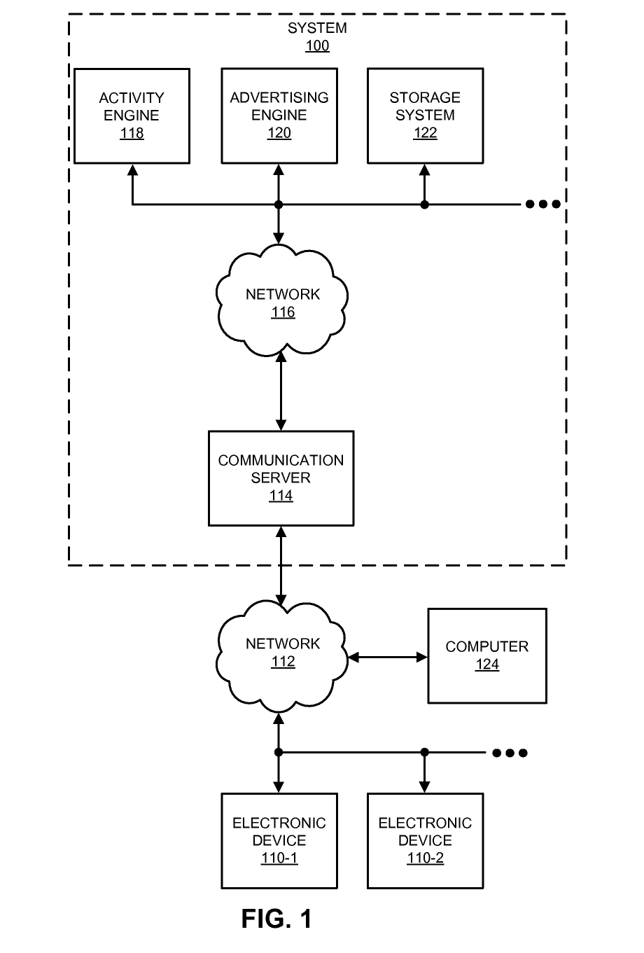

We now describe embodiments of the system and its use. FIG. 1 presents a block diagram illustrating a system 100 that performs the advertising technique. In this system, users of electronic devices 110 may use a software product, such as instances of a software application that is resident on and that executes on electronic devices 110. In some implementations, the users may interact with a web page that is provided by communication server 114 via network 112, and which is rendered by web browsers on electronic devices 110. For example, at least a portion of the software application executing on electronic devices 110 may be an application tool that is embedded in the web page, and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and that executes on electronic devices 110).

Using one of electronic devices 110 (such as electronic device 110-1) as an illustrative example, a user of electronic device 110-1 may use the software application to interact with other users in a social network (and, more generally, a network of users), such as a professional social network, which facilitates interactions among the users. Note that each of the users of the software application may have an associated user profile that includes personal and professional characteristics and experiences, which are sometimes collectively referred to as ‘attributes’ or ‘characteristics.’ For example, a user profile may include: demographic information (such as age and gender), geographic location, work industry for a current employer, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors may include: log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network. Furthermore, the interactions among the users may help define a social graph in which nodes correspond to the users and edges between the nodes correspond to the users' interactions, interrelationships, and/or connections.

In particular, when using the software application, the users may post content or data items in the social network (which are sometimes referred to as ‘user posts’), such as: text, pictures, video, documents or files, presentations, etc. In addition, the users may post comments on other users' posts. For example, a user may indicate that they like a user post or may provide feedback about the user post. In general, user posts and/or comments may include: verbal, written, and/or recorded information. Note that the user posts or comments may be communicated to other users via the software application that executes in the environment of electronic devices 110. Moreover, the users providing the posts may include so-called ‘influencers,’ who interact with multiple other users in the social network and, therefore, who may be represented in the social graph by nodes having multiple edges.

Over time, via network 116, an activity engine 118 in system 100 may aggregate the user posts, the associated comments and, more generally, the user interactions with each other in the social network. Then, activity engine 118 may store the aggregated information in a data structure, which is stored in a computer-readable memory, such as storage system 122 that may encompass multiple devices, i.e., a large-scale storage system.

Subsequently, an advertiser (or a representative of the advertiser) may define or specify an advertising campaign. For example, using one of electronic devices 110 or a computer 124, the advertiser may provide information specifying a target audience and a daily budget for the advertising campaign. (However, in other embodiments, the disclosed advertising technique is used when the budget is over a different time interval, such as: an hour, a week, a month, a total budget over the entire advertising campaign, etc. In addition, in some embodiments the advertiser does not specify the daily budget. Instead, advertising engine 120 infers the budget by dividing the total budget by a time interval, such as 24 hours.) In particular, the target audience may be specified based on the characteristics or attributes of the individuals in the target audience. Advertising engine 120 may receive this information, and then may store it in a data structure, which is stored in a computer-readable memory, such as storage system 122.

Subsequently, advertising engine 120 may use this information to determine when to provide advertisements that are displayed on electronic device 110. These advertising impressions may be targeted based on the target audience for the advertising campaign, as well as current locations of electronic devices 110, a time of day, a day of the week, a time of year, activities of the users, etc. In some embodiments, advertising engine 120 concurrently runs multiple advertising campaigns for different advertisers. At a given time, advertising program modules for these advertising campaigns, which are executed by advertising engine 120, may make bids to provide an advertising impression to a given user of electronic devices 110 (such as a user of advertising device 110-1). In turn, advertising engine 120 may select one or more ‘winners’ of such an auction (e.g., based on a ranking of the values of the bids), and then may provide or serve one or more associated advertising impressions to electronic device 110-1, which are displayed to the user.

At the given time, a given advertising program module may dynamically adjust a target-audience probability of making a bid and/or may adjust the bid value (and, thus, may directly or indirectly increase or decrease the probability of providing an advertising impression to the electronic devices used by individuals in the associated target audience). In particular, advertising engine 120 may keep track of and may store (in storage system 122) the advertising impressions provided to different individuals during different advertising campaigns as a function of time on different days. Based on this information, advertising engine 120 may determine and may store (in storage system 122) an average historical cumulative number of advertising impressions as a function of time on a given day for the target audience based on previous advertising campaigns and/or previous days in the current advertising campaign.

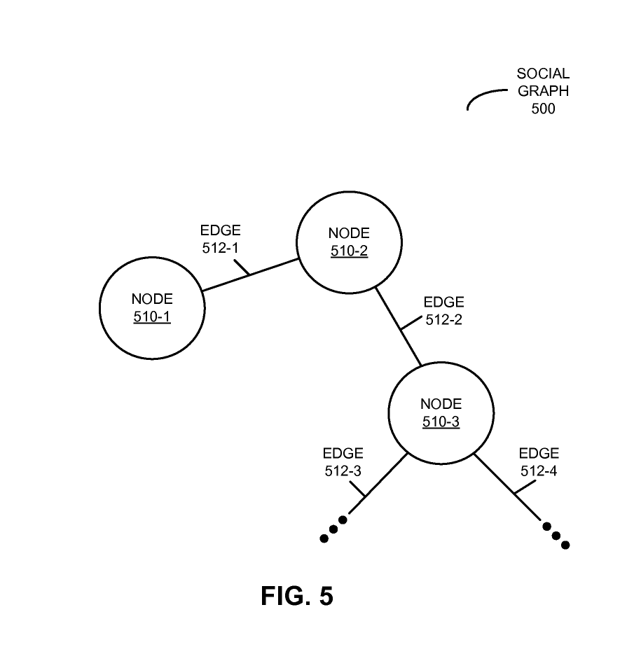

As described further below with reference to FIG. 5, if a current cumulative number of served advertising impressions at a given time for the target audience in the advertising campaign is below the historical cumulative number of advertising impressions at the given time, and if the daily budget for the advertising campaign has not yet been expended, the advertising program module for the advertising campaign may increase the target-audience probability of making a bid. For example, the initial target-audience probability at midnight may be 10%. Over the course of the day (such as every three minutes), the advertising program module for the advertising campaign may perform the aforementioned logical checks and, if these conditions are achieved, the target-audience probability may be increased incrementally (such as by using systematic under-relaxation or by multiplying the target-audience probability by (1+α), where α equals, e.g., 10%) until the target-audience probability is 100%.

Similarly, if the current cumulative number of advertising impressions at the given time for the target audience in the advertising campaign is above the historical cumulative number of advertising impressions at the given time, and if the daily budget for the advertising campaign has not been expended, the advertising program module for the advertising campaign may decrease the target-audience probability of making a bid. (Alternatively, instead of decreasing the target-audience probability, the advertising program module may decrease the bid value.) In addition, toward the end of the given day, if the daily budget has not been consumed, the advertising program module may increase the target-audience probability of providing advertising impressions to the target audience to 100%. For example, the target-audience probability in the last two hours of the given day may be 100%.

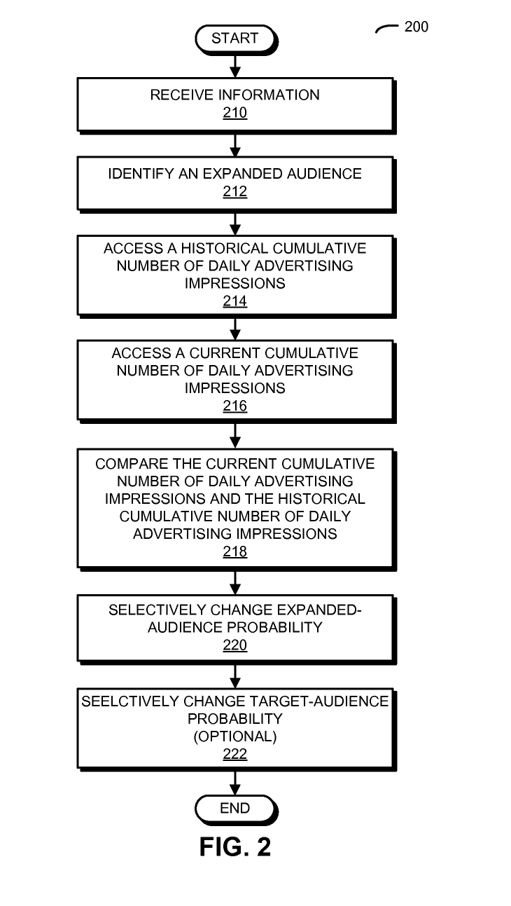

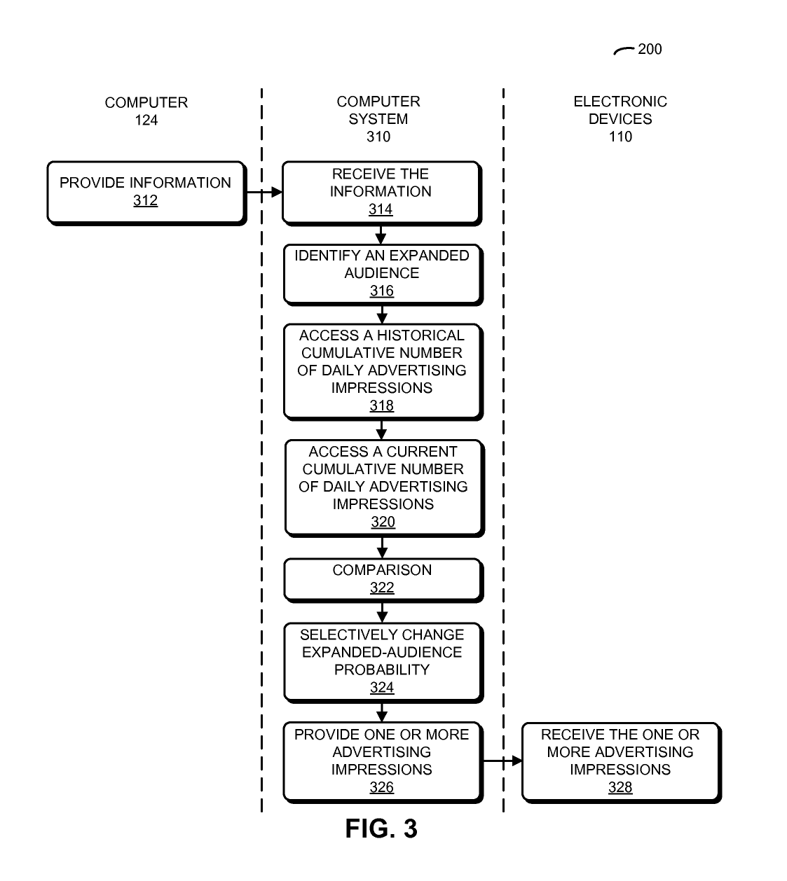

However, as noted previously, this approach to providing or serving advertising impressions to the users of electronic devices 110 may be too precise or narrow, or may miss advertising opportunities. As described further below with reference to FIGS. 2 and 3, in order to address this problem an advertising technique may identify an expanded audience, with individuals other than those in the target audience. For example, the characteristics or attributes of the individuals in the target audience may be used to identify individuals in the expanded audience. These characteristics or attributes may include those of the users of the social network. In particular, the advertising program module may use predetermined correlations among different job titles, user skills, companies or employers, and/or groups that the users follow. In some embodiments, these correlations are determined directly. Alternatively, in some embodiments the correlations are determined indirectly, such as based on job transitions. Therefore, when individuals transition or change jobs, associations between their previous and current job titles and companies or employers may be determined. In addition, associations may be determined between the user skills posted by prospective employers for these jobs with those of the individuals. In these ways, the advertising program module may identify the expanded audience.

Subsequently, the advertising program module for the advertising campaign may perform the logical checks. If a current cumulative number of advertising impressions at the given time for the target audience in the advertising campaign is below the historical cumulative number of advertising impressions at the given time, and if the campaign's daily budget has not been fully depleted, the advertising program module may increase the expanded-audience probability of making a bid to serve advertising impressions to the expanded audience.

In some embodiments, the expanded-audience probability of providing advertising impressions to the expanded audience is only increased when the probability of providing advertising impressions to the target audience is 100%. Over the course of the day (such as every three minutes), the advertising program module for the advertising campaign may perform the aforementioned logical checks, and if these conditions are achieved, the expanded-audience probability may be increased incrementally (such as by using systematic under-relaxation or by multiplying the probability by (1+α), where α equals, e.g., 10%) until the expanded-audience probability is 100%. In addition, toward the end of the given day, if the daily budget has not been consumed and the aforementioned conditions are achieved, the advertising program module may increase the expanded-audience probability of providing advertising impressions to the expanded audience to 100%. For example, the expanded-audience probability in the last two hours of the given day may be 100%.

In these ways, the advertising technique may dynamically and opportunistically expand the audience for the advertising campaign to maximize the impact of the allocated advertising dollars or daily budget for the advertising campaign. This advertising technique may allow the target audience to be expanded, when possible, to reach a larger expanded audience in a targeted and cost-effective manner.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

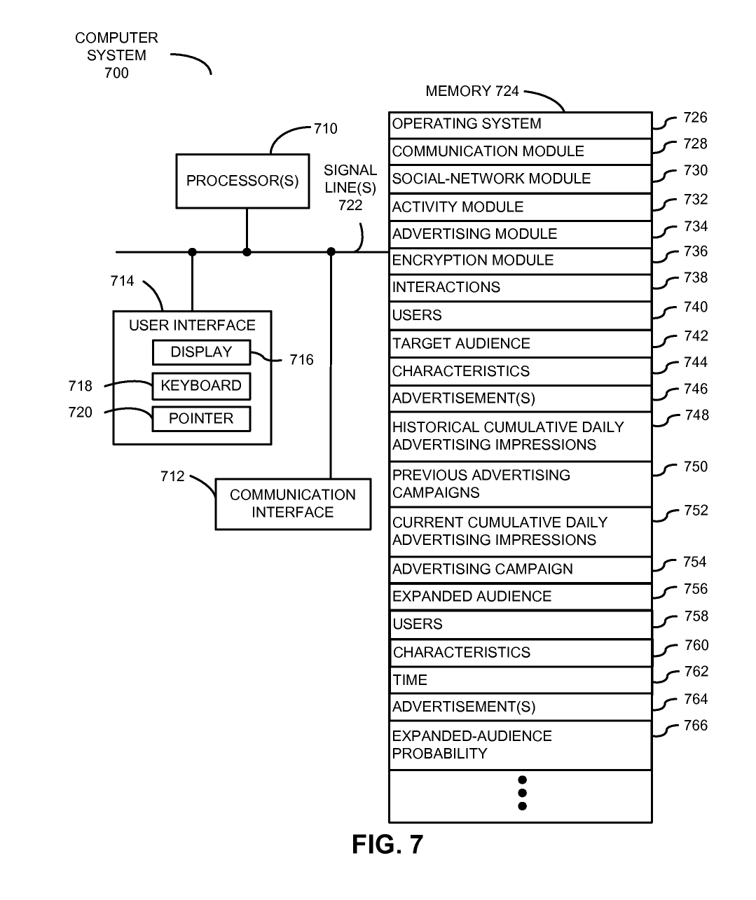

We now describe embodiments of the advertising technique. FIG. 2 presents a flow chart illustrating a method 200 for expanding an audience for an advertising campaign, which may be performed by a computer system (such as system 100 in FIG. 1 or computer system 700 in FIG. 7). During operation, the computer system receives information (operation 210) specifying a target audience and a daily budget for the advertising campaign. Then, the computer system identifies an expanded audience (operation 212) for the advertising campaign based on characteristics of individuals in the expanded audience and the target audience, where the expanded audience includes individuals outside of the target audience. For example, the expanded audience may be identified based on individual-specific characteristics, such as: a job title, employer information, skills of the individuals, and/or associations with groups (such as groups of individuals that the individuals ‘follow’ in a social network). In some embodiments, the individuals in the expanded audience are identified based on (directly or indirectly determined) correlations with the skills and/or the groups associated with the individuals in the target audience. Note that the characteristics may be associated with profiles of the individuals in a social network of professionals.

In an exemplary embodiment, the expanded audience is identified based on a metric, such as the distance, the square of the distance or a correlation coefficient, in a high-dimensional space of values of the characteristics of the individuals outside of the target audience and the values of the of the characteristics of the individuals in the target audience. For example, the metric may be computed as the sum of the square of the differences of the values of the characteristics for the individuals outside of the target audience and the values of the characteristics for the individuals in the target audience. Those individuals having metrics less than a threshold (which may be based on the desired size of the expanded audience) may be included in the expanded audience. Alternatively or additionally, the characteristics of the individuals that are outside of the target audience may be a superset of the characteristics of the individuals in the target audience. Thus, the characteristics of the individuals in the target audience may include those who worked for a particular employer or who live in a particular town, and the characteristics of the individuals in the expanded audience may include those who worked in the same industry as the employer or who live in a region that includes the town. In these ways, the similarity of the individuals in the target audience and the expanded audience may be determined using the metrics and/or set theory as applied to a high-dimensional space of the characteristics of individuals.

In some embodiments, the expanded audience is determined based on characteristics of the target audience (as opposed to the characteristics of the individuals in the target audience). For example, if the target audience includes users of ‘Java,’ the expanded audience may include users of ‘C++.’

Moreover, the computer system accesses (or obtains) a historical cumulative number of daily advertising impressions (operation 214) served by a given time to the target audience based on previous advertising campaigns and/or the current advertising campaign (such as previous days during the current advertising campaign). For example, the computer system may access the historical cumulative number of daily advertising impressions in a computer-readable memory, such as storage system 122 (FIG. 1). Similarly, the computer system accesses (or obtains) a current cumulative number of daily advertising impressions (operation 216) served by the given time to the target audience in the advertising campaign, where a total cost of the current cumulative number of daily advertising impressions is less than the daily budget for the advertising campaign. Once again, the computer system may access the current cumulative number of daily advertising impressions in a computer-readable memory, such as storage system 122 (FIG. 1).

Next, the computer system compares, at the given time, the current cumulative number of daily advertising impressions to the historical cumulative number of daily advertising impressions (operation 218).

Furthermore, the computer system selectively changes an expanded-audience probability (operation 220) of showing advertisements in the advertising campaign to individuals in the expanded audience based on the comparison. For example, when the current cumulative number of daily advertising impressions is less than the historical cumulative number of daily advertising impressions, the computer system may increase the expanded-audience probability.

Note that the increased expanded-audience probability may increase a likelihood that the advertising campaign will participate in an auction for showing an advertisement to an individual in the expanded audience. In addition, as noted previously, in some embodiments the expanded-audience probability is only increased when a target-audience probability of showing advertisements in the advertising campaign to individuals in the target audience is 100%.

Similarly, when the current cumulative number of daily advertising impressions is greater than the historical cumulative number of daily advertising impressions, the computer system may decrease the expanded-audience probability.

In some embodiments, the computer system optionally selectively changes the target-audience probability (operation 222) based on the comparison. For example, when the current cumulative number of daily advertising impressions is less than the historical cumulative number of daily advertising impressions and/or the campaign's budget is not fully depleted, the computer system may increase the target-audience probability. Similarly, when the current cumulative number of daily advertising impressions is greater than the historical cumulative number of daily advertising impressions, the computer system may reduce the target-audience probability.

In an exemplary embodiment, method 200 is implemented using one or more electronic devices and at least one server (and, more generally, a computer system), which communicate through a network, such as a cellular-telephone network and/or the Internet (e.g., using a client-server architecture). This is illustrated in FIG. 3. During this method, computer 124 provides information 312 to computer system 310. For example, an advertiser may enter or provide the information specifying the target audience (including characteristics of the individuals in the target audience, as well as demographic information specifying the individuals) and the daily budget for the advertising campaign using a user interface displayed on computer 124. Then, the information may be communicated to computer system 310.

After receiving the information 314, computer system 310 may identify an expanded audience 316 for the advertising campaign. For example, computer system 310 may compare the characteristics of the individuals in the target audience and characteristics of the individuals in the expanded audience. This analysis may be performed on an individual basis and/or using the aggregate characteristics of a group of individuals. For example, for each of one or more specific attributes of targeted individuals (e.g., a specific skill, a specific employer, a specific job title), computer system 310 may identify one or more attributes that are different but comparable (e.g., a related skill, a comparable employer, a similar job title).

Moreover, computer system 310 may access (or obtain) a historical cumulative number of daily advertising impressions 318 at a given time for the target audience based on previous advertising campaigns and/or the current advertising campaign, and the computer system may access (or obtain) a current cumulative number of daily advertising impressions 320 at the given time for the target audience in the advertising campaign.

Next, as long as the daily budget for the advertising campaign has not been expended, and/or a target-audience probability equals 100%, computer system 310 compares 322, at the given time, the current cumulative number of daily advertising impressions to the historical cumulative number of daily advertising impressions.

Based on this comparison, computer system 310 may selectively change an expanded-audience probability 324. For example, when the current cumulative number of daily advertising impressions is less than the historical cumulative number of daily advertising impressions (at the given time during a day, e.g., 2 pm), computer system 310 may increase the expanded-audience probability. This may make it more likely computer system 310 participates in an auction to provide or serve one or more advertising impressions (such as advertisements that include text, audio, an image, video and, more generally, any sensory information) in the advertising campaign to one or more users of one or more of electronic devices 110. If the advertising campaign's bid wins the auction, computer system 310 may provide one or more advertising impressions 326 to one or more electronic devices 110, which are subsequently received 328 by one or more of electronic devices 110. Participation in an auction by a given advertising campaign may be based on multiple factors, such as the expanded-audience probability, the target-audience probability, the number of other bidders, the bid value, the daily budget, the rate of consumption of the daily budget, the given time, locations of the users, a threshold value, etc. Alternatively, there may not be an auction. Instead, based on the expanded-audience probability, computer system 310 may provide the one or more advertising impressions 326 to one or more of electronic devices 110, such as when the expanded-audience probability exceeds a threshold value (e.g., 50%).

In some embodiments of method 200 (FIGS. 2 and 3), there may be additional or fewer operations. Moreover, the order of the operations may be changed, and/or two or more operations may be combined into a single operation. For example, instead of using cumulative daily advertising impressions, cumulative advertising impressions during a different time interval (such as a week or a month) may be used. Alternatively or additionally, instead of using the current cumulative daily advertising impressions at the given time, a projection or forecast of the current cumulative daily advertising impressions at the given time (which may be based on either the available current cumulative daily advertising impressions at times previous times during a day and/or the historical cumulative daily advertising impressions) is used.

Furthermore, instead of comparing current cumulative advertising impressions to historical advertising impressions, a current rate or percentage of consumption of an advertising campaign's budget (e.g., a daily budget) may be determined, and may be compared to a historical rate or percentage of consumption. In this case, if the campaign's current depletion of its budget is lower (or higher) than the historical depletion, the target-audience probability and/or expanded-audience probably may be increased (or decreased).

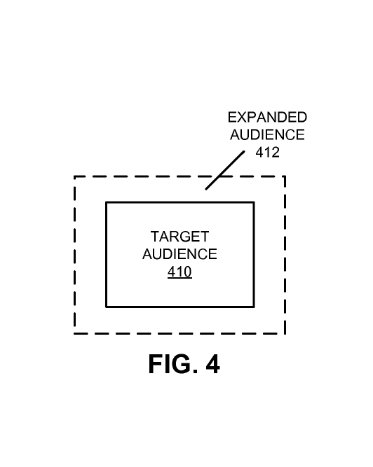

In an exemplary embodiment, the advertising technique is used to expand the audience for an advertising campaign. This is illustrated in FIG. 4, which presents a drawing illustrating a target audience 410 and an expanded audience 412 for the advertising campaign. For example, the advertising campaign may be a job-recruitment promotion for company A. The target audience 410 may include individuals who are 25-38 years of age, who live in a particular region (such as the West Coast of the United States), and who earn between $75,000 and $100,000 per year. These individuals may work as software engineers (the job title), at Fortune 100 high-technology companies (the employer information), who have experience coding in a particular software language B or environment C (the skills of the individuals), and/or may have associations with groups D of software developers (e.g., the individuals in target audience 410 may follow postings by groups D of software developers who develop software programs using software language B or in environment C).

As noted previously, the characteristics of the individuals in target audience 410 may include those of some of the users of a social network (such as the information in user profiles) and/or the interactions of the individuals with other users in the social network. Thus, the characteristics of the individuals in target audience 410 may include the factors listed above, such as: demographic information, geographic location, a current employer, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors may include: log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network. Furthermore, the interactions among the users may help define a social graph in which nodes correspond to the users and edges between the nodes correspond to the users' interactions, interrelationships, and/or connections.

FIG. 5 presents a drawing illustrating a social graph 500. This social graph includes nodes 510 corresponding to individuals and edges 512 corresponding to connections among the individuals corresponding to nodes 510. For example, edges 512 may represent interrelationships among the individuals or entities, such as organizations (companies, schools, etc.) that the individuals are (or used to be) associated with. Thus, edges 512 may represent interrelationships among individuals and/or entities, such as companies where they worked, schools they attended, etc. As a consequence, social graph 500 may be used to determine an affinity or similarity metric, for example, by counting or tracing edges 512 between current members of the organization and the individual.

Referring back to FIG. 4, the computer system may use user profiles and social graph 500 (FIG. 5) to identify individuals in expanded audience 412. In particular, the social network may be used by individuals seeking new jobs and by employers seeking new employees. As the users switch jobs over time, the relationships (which may directly or indirectly specify correlations) between different job titles, seniority, employers, skills, associated groups, etc. may be specified (e.g., by affinity or similarity metrics). This information may be used to identify individuals in expanded audience 412 who, while different from the individuals in target audience 410, are similar (e.g., their characteristics and, thus, it is hoped, their interests and employment suitability) to the individuals in target audience 410.

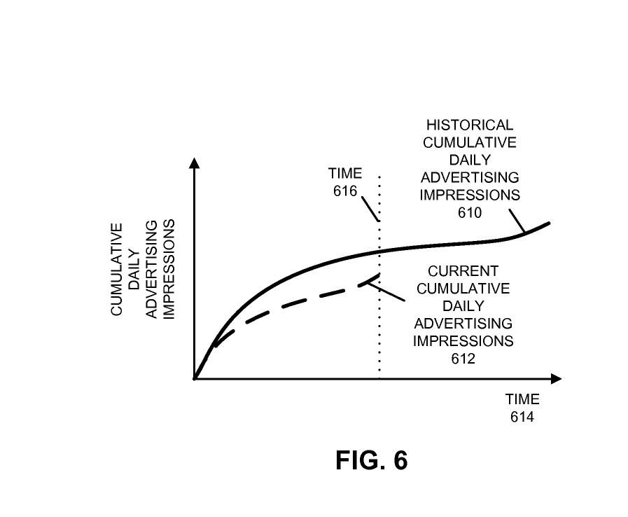

After identifying expanded audience 412, the computer system may dynamically determine when to bid in an advertising auction and/or when to provide an advertising impression to at least one of the individuals in expanded audience 412. This is shown in FIG. 6, which presents a drawing illustrating historical cumulative daily advertising impressions 610 as a function of time 614 (e.g., during a 24-hour time interval) and current cumulative daily advertising impressions 612 as a function of time 614. Note that historical cumulative daily advertising impressions 610 may be the average cumulative daily number of advertising impressions provided to individuals in target audience 410 (FIG. 4) the same or similar advertising campaigns over one or more previous time periods (i.e., the average summed number of advertising impressions presented at different times of the day, starting with zero impressions at midnight and monotonically rising to a maximum value 24 hours later). Ideally, the maximum value corresponds to a cost equal to 100% of the average daily budget of the previous advertising campaigns (i.e., full depletion of the daily budget).

Similarly, current cumulative daily advertising impressions 612 may be the cumulative daily number of advertising impressions provided to individuals in target audience 410 (FIG. 4) in the current advertising campaign (i.e., the summed number of advertising impressions presented at different times of the day, starting with zero impressions at midnight and monotonically rising to a maximum value 24 hours later). The goal of the advertising technique is to help ensure that the maximum value corresponds to a cost equal to 100% of the daily budget of the advertising campaign.

Thus, the computer system may dynamically use excess funds in the daily budget to target individuals in expanded audience 412 (FIG. 4). In particular, at any given time, such as time 616, the computer system may compare the value of historical cumulative daily advertising impressions 610 and current cumulative daily advertising impressions 612. If current cumulative daily advertising impressions 612 is less than historical cumulative daily advertising impressions 610, the expanded-audience probability may be increased. Alternatively, if current cumulative daily advertising impressions 612 is greater than historical cumulative daily advertising impressions 610, the expanded-audience probability may be decreased.

We now describe embodiments of a computer system for performing the advertising technique and its use. FIG. 7 presents a block diagram illustrating a computer system 700 that performs method 200 (FIGS. 2 and 3), such as system 100 in FIG. 1. Computer system 700 includes one or more processing units or processors 710 (which are sometimes referred to as a ‘processing module’), a communication interface 712, a user interface 714, memory 724, and one or more signal lines 722 coupling these components together. Note that the one or more processors 710 may support parallel processing and/or multi-threaded operation, the communication interface 712 may have a persistent communication connection, and the one or more signal lines 722 may constitute a communication bus. Moreover, the user interface 714 may include: a display 716 (such as a touchscreen), a keyboard 718, and/or a pointer 720 (such as a mouse).

Memory 724 in computer system 700 may include volatile memory and/or non-volatile memory. More specifically, memory 724 may include: ROM, RAM, EPROM, EEPROM, flash memory, one or more smart cards, one or more magnetic disc storage devices, and/or one or more optical storage devices. Memory 724 may store an operating system 726 that includes procedures (or a set of instructions) for handling various basic system services for performing hardware-dependent tasks. Memory 724 may also store procedures (or a set of instructions) in a communication module 728. These communication procedures may be used for communicating with one or more computers and/or servers, including computers and/or servers that are remotely located with respect to computer system 700.

Memory 724 may also include multiple program modules (or sets of instructions), including: social-network module 730 (or a set of instructions), activity module 732 (or a set of instructions), advertising module 734 (or a set of instructions), and/or encryption module 736 (or a set of instructions). Note that one or more of these program modules (or sets of instructions) may constitute a computer-program mechanism.

During operation of computer system 700, social-network module 730 facilitates interactions 738 among users 740 (in a target audience 742 having characteristics 744) via communication module 728 and communication interface 712. These interactions may be tracked by activity module 732, and may include user posts and associated comments. Then, advertising module 734 may provide, via communication module 728 and communication interface 712, one or more advertisements 746 (which are sometimes referred to as ‘advertising impressions’). Advertising module 734 may aggregate these advertisements 746 into a record of historical cumulative daily advertising impressions 748 for previous advertising campaigns 750 (or the current advertising campaign) and a record of current cumulative daily advertising impressions 752 for a current advertising campaign 754.

Furthermore, advertising module 734 may identify expanded audience 756 based on characteristics 760 of additional individuals or users 758. Then, advertising module 734 may compare historical cumulative daily advertising impressions 748 and current cumulative daily advertising impressions 752 at a given time 762. Based on this comparison, advertising module 734 may provide advertisements 764 to one or more of users 758 in expanded audience 756. For example, if historical cumulative daily advertising impressions 748 is greater than current cumulative daily advertising impressions 752 at time 762, an expanded-audience probability 766 may be increased.

Because information in computer system 700 may be sensitive in nature, in some embodiments at least some of the data stored in memory 724 and/or at least some of the data communicated using communication module 728 is encrypted using encryption module 736.

Instructions in the various modules in memory 724 may be implemented in a high-level procedural language, an object-oriented programming language, and/or in an assembly or machine language. Note that the programming language may be compiled or interpreted, e.g., configurable or configured, to be executed by the one or more processors.

Although computer system 700 is illustrated as having a number of discrete items, FIG. 7 is intended to be a functional description of the various features that may be present in computer system 700 rather than a structural schematic of the embodiments described herein. In practice, and as recognized by those of ordinary skill in the art, the functions of computer system 700 may be distributed over a large number of servers or computers, with various groups of the servers or computers performing particular subsets of the functions. In some embodiments, some or all of the functionality of computer system 700 is implemented in one or more application-specific integrated circuits (ASICs) and/or one or more digital signal processors (DSPs).

Computer systems (such as computer system 700), as well as electronic devices, computers and servers in system 100 (FIG. 1), may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 112 (FIG. 1) may include: the Internet, World Wide Web (WWW), an intranet, a cellular-telephone network, LAN, WAN, MAN, or a combination of networks, or other technology enabling communication between computing systems.

System 100 (FIG. 1) and/or computer system 700 may include fewer components or additional components. Moreover, two or more components may be combined into a single component, and/or a position of one or more components may be changed. In some embodiments, the functionality of system 100 (FIG. 1) and/or computer system 700 may be implemented more in hardware and less in software, or less in hardware and more in software, as is known in the art.

While a social network has been used as an illustration in the preceding embodiments, more generally the advertising technique may be used to expand the audience of the advertising campaign in a wide variety of applications or systems. Moreover, the advertising technique may be used in applications where the communication or interactions among different entities (such as people, organizations, etc.) can be described by a social graph. Note that the people may be loosely affiliated with a website (such as viewers or users of the website), and thus may include people who are not formally associated (as opposed to the users of a social network who have user accounts). Thus, the connections in the social graph may be defined less stringently than by explicit acceptance of requests by individuals to associate or establish connections with each other, such as people who have previously communicated with each other (or not) using a communication protocol, or people who have previously viewed each other's home pages (or not), etc. In this way, the advertising technique may be used to expand the quality of interactions and value-added services among relevant or potentially interested people in a more loosely defined group of people.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-implemented method for expanding an audience for an advertising campaign, the method comprising:
receiving information specifying a target audience and a daily budget for the advertising campaign;
identifying an expanded audience for the advertising campaign based on characteristics of individuals in the expanded audience and the target audience, wherein the expanded audience includes individuals outside of the target audience;
accessing a historical cumulative advertising performance metric at a given time for the target audience based on one of: previous advertising campaigns, and the advertising campaign;
accessing a current cumulative advertising performance metric at the given time for the target audience in the advertising campaign, wherein a cost of the current cumulative number of daily advertising impressions is below the daily budget for the advertising campaign;
using the computer, comparing, at the given time, the current cumulative advertising performance metric to the historical cumulative advertising performance metric; and
selectively changing an expanded-audience probability of showing advertisements in the advertising campaign to individuals in the expanded audience based on the comparison.

2. The method of claim 1, wherein the historical cumulative advertising performance metric includes one of: a historical cumulative number of daily advertising impressions at the given time for the target audience based on previous advertising campaigns; a historical cumulative number of daily advertising impressions at the given time for the target audience based on previous days in the advertising campaign; a historical cumulative consumption of a daily budget at the given time for the target audience based on previous advertising campaigns, and a historical cumulative consumption of the daily budget at the given time for the target audience based on previous days in the advertising campaign.

3. The method of claim 1, wherein the current cumulative advertising performance metric includes one of: a current cumulative number of daily advertising impressions at the given time for the target audience in the advertising campaign; and a current cumulative consumption of the daily budget at the given time for the target audience based on the advertising campaign.

4. The method of claim 1, wherein the expanded-audience probability is increased when the current cumulative advertising performance metric is less than the historical cumulative advertising performance metric; and
wherein the increased expanded-audience probability increases a likelihood of the advertising campaign participating in an auction for showing an advertisement to an individual in the expanded audience.

5. The method of claim 1, wherein, when the current cumulative advertising performance metric is less than the historical cumulative advertising performance metric and a target-audience probability of showing advertisements in the advertising campaign to individuals in the target audience is 100%, the expanded-audience probability of showing the advertisements in the advertising campaign to the individuals in the expanded audience is increased.

6. The method of claim 1, wherein the expanded audience is identified based on individual-specific characteristics.

7. The method of claim 1, wherein, when the current cumulative advertising performance metric is greater than the historical cumulative advertising performance metric, the expanded-audience probability is decreased.

8. The method of claim 1, wherein the characteristics of the individuals include: a job title, employer information, skills of the individuals, and associations with groups.

9. The method of claim 8, wherein the characteristics are associated with profiles of the individuals in a professional social network.

10. The method of claim 8, wherein the individuals in the expanded audience are identified based on correlations with one of the skills and the groups associated with the individuals in the target audience.

11. An apparatus, comprising:
one or more processors;
memory; and
a program module, wherein the program module is stored in the memory and, during operation of the apparatus, is executed by the one or more processors to expand an audience for an advertising campaign, the program module including:
instructions for receiving information specifying a target audience and a daily budget for the advertising campaign;
instructions for identifying an expanded audience for the advertising campaign based on characteristics of individuals in the expanded audience and the target audience, wherein the expanded audience includes individuals outside of the target audience;
instructions for accessing a historical cumulative advertising performance metric at a given time for the target audience based on one of:
previous advertising campaigns, and the advertising campaign;
instructions for accessing a current cumulative advertising performance metric at the given time for the target audience in the advertising campaign, wherein a cost of the current cumulative number of daily advertising impressions is below the daily budget for the advertising campaign;
instructions for comparing, at the given time, the current cumulative advertising performance metric to the historical cumulative advertising performance metric; and
instructions for selectively changing an expanded-audience probability of showing advertisements in the advertising campaign to individuals in the expanded audience based on the comparison.

12. The apparatus of claim 11, wherein the historical cumulative advertising performance metric includes one of: a historical cumulative number of daily advertising impressions at the given time for the target audience based on previous advertising campaigns; a historical cumulative number of daily advertising impressions at the given time for the target audience based on previous days in the advertising campaign; a historical cumulative consumption of a daily budget at the given time for the target audience based on previous advertising campaigns, and a historical cumulative consumption of the daily budget at the given time for the target audience based on previous days in the advertising campaign.

13. The apparatus of claim 11, wherein the current cumulative advertising performance metric includes one of: a current cumulative number of daily advertising impressions at the given time for the target audience in the advertising campaign; and a current cumulative consumption of the daily budget at the given time for the target audience based on the advertising campaign.

14. The apparatus of claim 11, wherein the expanded-audience probability is increased when the current cumulative advertising performance metric is less than the historical cumulative advertising performance metric; and
wherein the increased expanded-audience probability increases a likelihood of the advertising campaign participating in an auction for showing an advertisement to an individual in the expanded audience.

15. The apparatus of claim 11, wherein, when the current cumulative advertising performance metric is less than the historical cumulative advertising performance metric and a target-audience probability of showing advertisements in the advertising campaign to individuals in the target audience is 100%, the expanded-audience probability of showing the advertisements in the advertising campaign to the individuals in the expanded audience is increased.

16. The apparatus of claim 11, wherein, when the current cumulative advertising performance metric is greater than the historical cumulative advertising performance metric, the expanded-audience probability is decreased.

17. The apparatus of claim 11, wherein the characteristics of the individuals include: a job title, employer information, skills of the individuals, and associations with groups.

18. The apparatus of claim 17, wherein the characteristics are associated with profiles of the individuals in a professional social network.

19. The apparatus of claim 17, wherein the individuals in the expanded audience are identified based on correlations with one of the skills and the groups associated with the individuals in the target audience.

20. A system, comprising:
a processing module comprising a non-transitory computer-readable medium storing instructions that, when executed, cause the system to:
receive information specifying a target audience and a daily budget for the advertising campaign;
identify an expanded audience for the advertising campaign based on characteristics of individuals in the expanded audience and the target audience, wherein the expanded audience includes individuals outside of the target audience;
access a historical cumulative advertising performance metric at a given time for the target audience based on one of: previous advertising campaigns, and the advertising campaign;
access a current cumulative advertising performance metric at the given time for the target audience in the advertising campaign, wherein a cost of the current cumulative number of daily advertising impressions is below the daily budget for the advertising campaign;
compare, at the given time, the current cumulative advertising performance metric to the historical cumulative advertising performance metric; and
selectively change an expanded-audience probability of showing advertisements in the advertising campaign to individuals in the expanded audience based on the comparison.
